(19) United States
(12) Patent Application Publication
(10) Pub. No.: US 2012/0003913 A1
(43) Pub. Date: Jan. 5, 2012

(54) Air barrier

(76) Inventor: Melvin E. Shaffer, Kokomo, IN (US)

(21) Appl. No.: 12/803,645

(22) Filed: Jul. 1, 2010

(51) Int. Cl. F24F 13/18; E06B 7/02

(52) U.S. Cl. 454/195; 454/200

(57) ABSTRACT

A heat transfer inhibitor system to minimize the heat transfer through the structural opening closures with an interior and an exterior panel such as windows, doors and skylights that are the weak links in interior insulation. By moving a stream of constant temperature air through a space between the external panel and the interior panel, the temperature differential between the exterior surface of the internal panel and the interior is minimized thus reducing the load and maintenance costs on heater/AC systems. It also reduces the required size and costs of installations.

### BACKGROUND

1. Field of Invention

The Air Barrier invention relates generally to a system for minimizing the heat transfer through structural openings in residential and commercial construction where the closures of those structural openings are formed with an interior panel, an exterior panel and an air gap in between the interior and exterior panels, such as windows with storm windows, doors with storm doors, or skylights. Minimizing the heat transfer through these closures of structural openings reduces the load on heating and cooling systems. More specifically it involves moving an almost constant temperature air through a gap between an outside panel and an inner panel. The moving air is held at a nearly constant temperature by cycling it through a heat exchanger which can be either a water to air system using well water at approximately 55 degrees Fahrenheit or an air to air heat exchanger blowing air through an underground thermally conductive tube of sufficient depth and length to offset temperature fluctuations that the moving air experiences as it travels through the closed system in insulated tubing.

2. Prior Art

Many attempts have been made to minimize the heat transfer through windows which typically accounts for the largest heat loss or gain in a normally insulated structure. Windows have the lowest thermal resistance or R-value of any standard building materials. Typically a 2×6 inch wall construction with R-19 fiberglass insulation has an R value of approximately 11.7 where a single pane glass window has a thermal resistance or R-value of 0.9. The addition of a second glass was tried, as in the storm window approach, to reduce that loss or inhibit that heat transfer. Two and three pane thermopane approaches were used in conjunction with storm windows with an air gap between the thermopane and the storm windows. Although static air is a good insulator, over time the temperature of trapped air inside the storm window gradually attains the temperature of the exterior air such that the temperature differential between the interior of the structure and the outside of the interior panel is the same as between the interior and the exterior temperature. The heat loss or transfer through a given opening is equal to the thermal conductivity of the materials in the closure times the area of the closure times the temperature differential between the interior and the exterior surface of the interior panel. To improve the thermal resistance of the gap between the windows, gasses with lower thermal conductivity than air such as argon, krypton and xenon were placed between the layers. These gasses are more expensive and tend to leak out over time with high replacement costs and fairly short life spans. The best Insulator for the gap is a perfect vacuum, but this puts a significant strain on the glass reducing the allowable span between supports and requires even more expensive seals. When the seal eventually fails it draws moisture into the space between windows clouding the visibility. Various coatings with different reflectivity and emissivity have also been proposed but add to the costs and some have negative impacts on visibility.

To date the prior art attempts to resolve this problem have been minimally effective but costly.

### SUMMARY OF THE INVENTION

The Air Barrier System utilizes a constant temperature air moving through the gap between an exterior panel and an interior panel. The interior panel and the exterior panel are separated by a spacer frame on each side, top and bottom and have air flow ports top and bottom to supply the moving air at the top or bottom depending on the ambient temperature. If heating is required, the constant temperature air source supplies air to the top port and is drawn off through the bottom port and returned to the constant temperature air source. If cooling is desired, air flow is reversed putting constant temperature air in to the bottom port from the constant temperature source and drawing it off through the top port to return to the constant temperature source. A plurality of structural opening closures can be hooked to a closed loop system with insulated tubing run from the constant temperature source to the top port of each closure, until the distal closure where the constant temperature air source is capped with a top line plug. The proximal end of the constant temperature return is capped with a bottom line plug and the successive bottom ports are connected with insulated tubing to the constant temperature air return which is returned with insulated tubing back to the constant temperature source. The top and bottom ports have openings to the gap between the exterior panels and the interior panels.

Constant temperature air may be provided by a heat exchanger outlet from either a water-to-air system or an air-to-air system or any other source that can provide a constant low velocity flow of regulated temperature air. The water to air system would consist of flowing well water through the heat exchanger, providing a nearly constant 55 degree Fahrenheit air stream to the ports. Blowing air through a sufficient length of conductive tubing buried deep enough in the ground to provide a similar constant temperature output to the ports is also possible

### DRAWINGS

In order that the invention is fully understood it will now be described with reference to the following drawings in which:

FIG. 1 is a block diagram of an Air Barrier System where the airflow is set for cool weather heating with a water to air heat exchanger.

FIG. 2 is a block diagram of an Air Barrier System where the airflow is set for warm weather cooling with a water to air heat exchanger.

FIG. 3 is a block diagram of an Air Barrier System where the airflow is set for warm weather cooling with an air to air heat exchanger.

FIG. 4 is a top view of an exterior wall with a structural opening closed with a spacer frame containing an interior panel, an exterior panel and a space between interior and exterior panels.

FIG. 5 is a section view of the two panel closure taken on cutting plane 5-5 in FIG. 4.

FIG. 6 is a section view of the two panel closure taken on cutting plane 6-6 in FIG. 4.

FIG. 7 is a section view of the two panel closure taken on cutting plane 7-7 in FIG. 4.

FIG. 8 is a partial perspective view of a heat exchanger with inlet and outlet reversal plate assembled.

FIG. 9 is an exploded perspective view of a heat exchanger and a flow reversal plate.

Building, power source, solar collectors, and energy storage devices are shown in broken lines, as they are not part of this invention but shown for illustrative purposes only.

### REFERENCE NUMBERS

The same reference numbers will be used throughout this application for the same and like features.

### DESCRIPTION

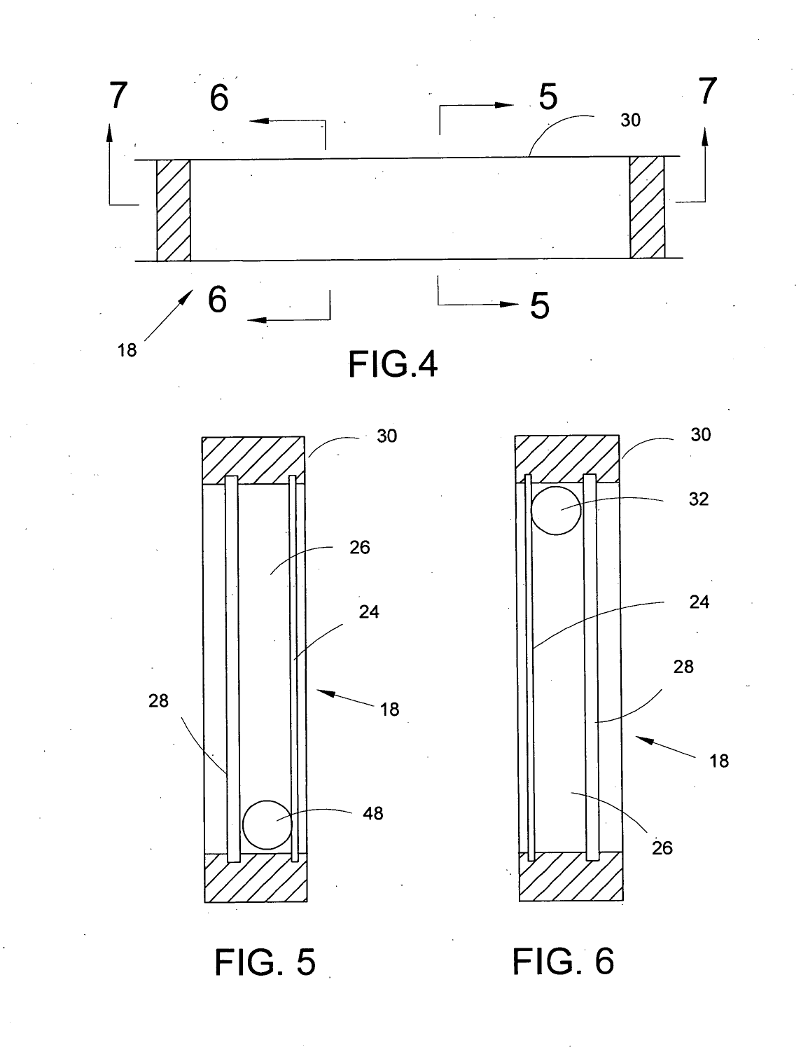

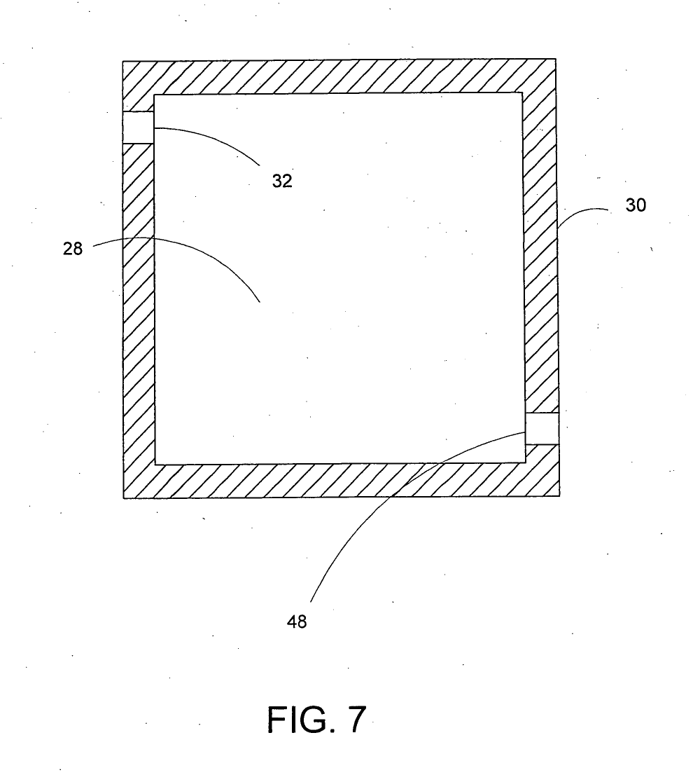

In order that Air Barrier System 10 is fully understood it will now be described by way of the following example. This new invention is a convenient and easily adaptable system for inhibiting the heat transfer through closures of structural openings in a wall. Air Barrier System 10 functions by pushing and pulling a stream of constant temperature air 42 through gap 26 between an exterior panel 24 and an interior panel 28. Panels 24 and 28 can be made from various materials and be composed of one or more layers or panes. Air Barrier System 10 utilizes closure 18 with top port 32 and bottom port 48, with a minimum of two panels 24 and 28 separated by spacer frame 30 around the panel sandwich as shown in FIGS. 4-7. Top port 32 is mounted in upper spacer frame 30 and bottom port 48 is mounted in opposite lower spacer frame 30. Ports 32 and 48 are mounted in such a manner that they open into gap 26. Constant temperature air 42 may be held at approximately 55 degrees Fahrenheit by either circulating well water through a water-to-air heat exchanger 12 or circulating air that has been blown through conductive tubing 14 that is buried at a sufficient depth with sufficient length to maintain a ground temperature of approximately 55 degrees Fahrenheit through an air-to-air heat exchanger 46.

Pumps, fans, solar collectors, and energy storage devices are not part of this invention and are shown for illustrative purposes only. Air-to-air and water-to-air heat exchangers 46 and 12 are shown as possible sources of constant temperature air 42. It does not need to be heated or cooled to fall well below the expected maximum temperature environment of 120 degrees Fahrenheit and well above the minimum expected temperature environment of −30 degrees Fahrenheit. This minimizes the temperature differential to the interior of the structure. In prior art trapped stationary air insulated gaps, conduction occurs between the external air, through the exterior panel 24 and into the trapped air gap 26 until the temperature of the air adjacent to the outside of interior panel 28 balances out to the external temperature. If the internal temperature of the structure is maintained at 72 degrees Fahrenheit, the amount of heat transferred through interior panel 28 is Q=U×A×ΔT. U is the thermal conductivity of the interior panel, or the inverse of thermal resistance 1/R; A is the cross sectional area of the panel; and ΔT is the temperature differential between the external air and the inside wall of interior panel 28. In the summer, if the inside of the structure is to be maintained at 72 degrees, the ΔT can reach (120−72)=48 degrees or in the winter ΔT can reach (−30+72)=102 degrees. This compares to Air Barrier System 10 in which the temperature of the flowing air 42 is held at 55 degrees Fahrenheit keeping the outside of interior panel 28 at approximately the same temperature vs. the internal structure temperature at 72 degrees where ΔT=(72−55)=17. It can be seen that keeping the air flowing at 55 degrees cuts the heat loss or transfer through interior panel 28 at the extremes by ratios of 17/48 and 17/102 or by approximately a 1/2 factor in summer and a 1/6 factor in winter.

Moving the constant temperature air 42 at an approximate rate of 2 to 3 cu. ft. per minute between exterior panel 24 and interior panel 28 also minimizes the conductive heat transfer across air gap 26 even further reducing the above ratios.

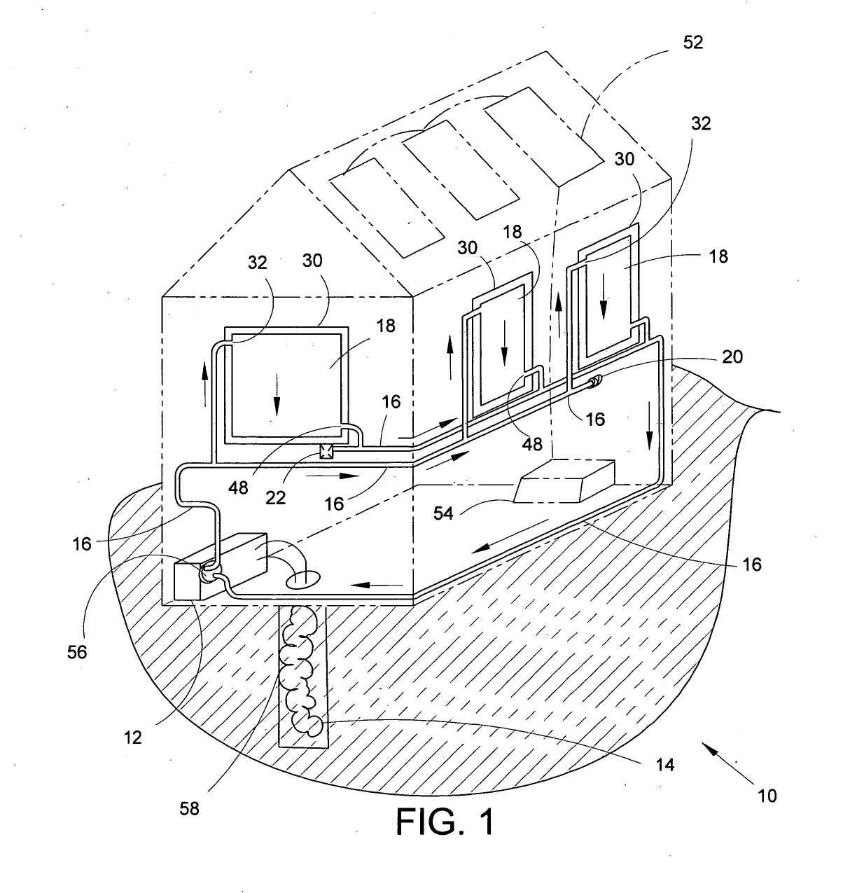

In order to minimize the work required by the heat exchanger 12 or 46 to move air 42 and compensate for slight variations in temperature of flowing air 42 and maintain a flow rate through the plurality of closures 18 connected to Air Barrier System 10, the plumbing schemes shown in FIGS. 1, 2 and 3 are utilized.

### Operation

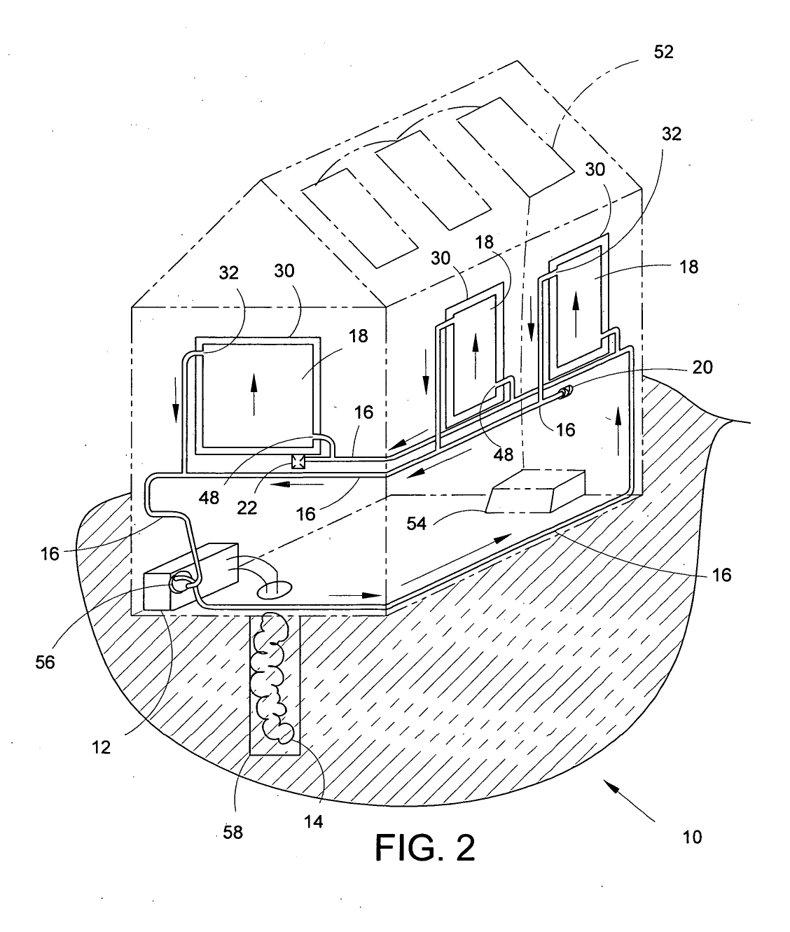

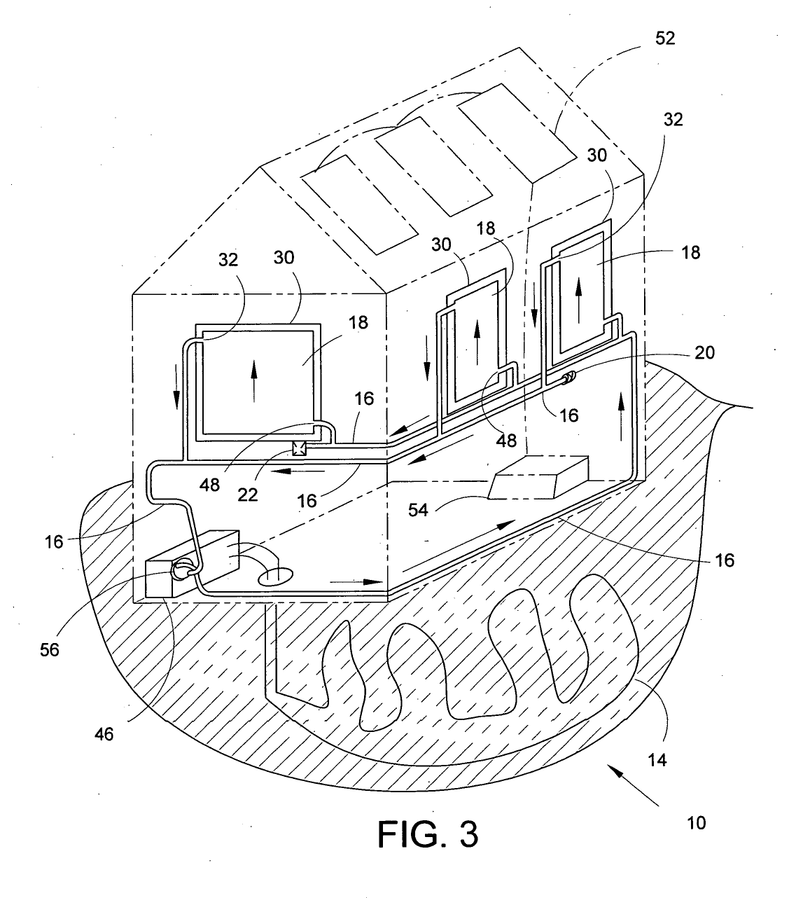

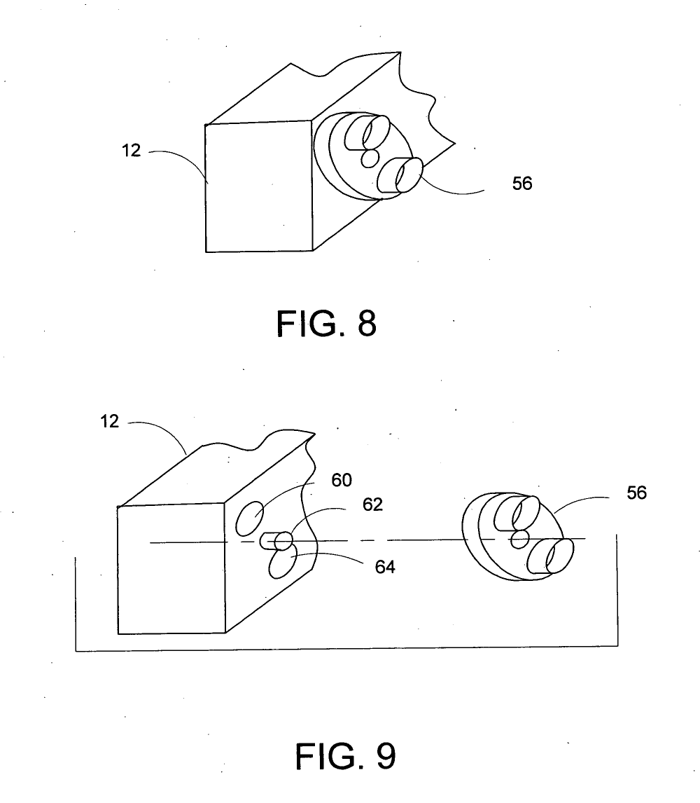

FIG. 1 shows the schematic for when heating is required. Constant temperature air 42 is supplied from heat exchanger 12 to top port 32 and drawn off at the bottom port 48 and returned to the heat exchanger 12. FIG. 2 shows the schematic for when cooling is desired. Air flow 42 is reversed, putting constant temperature air 42 in to bottom port 48 from heat exchanger 12 and drawing it off at top port 32 to return to the heat exchanger 12. This reversal of airflow can be obtained by rotating air reversal pivot plate 56 if the last sections of insulated tubing 16 are made from a flexible material. Outlet air orifice 60 is above and forward of pivot pin 62 and inlet orifice 64 is below and behind pivot pin. FIG. 3 shows the flow schematic utilizing an air to air heat exchanger 46. As shown in FIGS. 8 and 9, rotating pivot plate 56 has extensions that the flexible sections of insulated tubing 16 are slipped over and against which they can be clamped.

A plurality of structural opening closures 18 can be hooked to a closed loop system with insulated tubing 16 run from the constant temperature source to the top port 32 of each closure. After distal closure 18 the constant temperature air source is capped with top line plug 20. The proximal end of the constant temperature return is capped with bottom line plug 22 before proximal closure 18 and successive bottom ports 48 are connected with insulated tubing 16 to the constant temperature air return which flows through insulated tubing 16 back to the constant temperature source. This layout aids in balancing the flow through each gap 26. The proximal structural opening closure 18 has the highest input pressure and lowest return suction and the distal structural opening closure 18 has the lowest input pressure and the highest return suction tending to balance the flow through each gap 26. The top and bottom ports 32 and 48 have openings to gaps 26 between exterior panels 24 and interior panels 28.

Power to run the water pump or the fans to move subterranean air through conductive tubing 14 to the heat exchanger 12 and the fan to move the constant temperature air 42 through the heat exchanger 12 and through insulated tubing 16 to the various closures 18 and back to heat exchanger 12 can be provided from any of a variety of sources. Roof mounted solar collectors 52 with energy storage facilities 54 for night or grey days are an option although they represent maturing technologies and are not part of this invention.

The descriptions in the above specification are not intended to limit this invention to the application or the materials disclosed here. Rather, they are shown for illustration purposes only as one skilled in these arts could easily scale the invention's dimensions and materials to work with any size structural opening closure and conduit feeding constant temperature air through an air gap between panels that close a structural opening. The only limitations are as described in the attached claims.

What is claimed:

1. I claim a heat transfer inhibitor for a structural opening closure, comprised of:
a spacer frame that fits in said structural opening with a top, a bottom, two side walls, an interior side and an exterior side;
an exterior panel;
an interior panel, where said exterior panel and said interior panel are separated by said spacer frame forming a gap between said interior and exterior panels;
a top port that penetrates through side wall of said spacer frame toward said top into said gap;
a bottom port that penetrates through opposite side wall of said spacer frame toward said bottom into said gap;
a constant temperature air source connected to said top port by insulated tubing;
a constant temperature air return connected to said bottom port by said insulated tubing; and
said constant temperature air source and return have a flow reversing means that blows said constant temperature air into said top port when heating is required, drawing return air through said bottom port and returning it to said constant temperature air source and reversing the direction of flow for cooling, blows constant temperature air into said bottom port and draws its return air from said top port.

2. A heat transfer inhibitor for a structural opening closure as in claim 1 where said constant temperature air source utilizes a water well source of constant temperature fluid to cycle through a water-to-air heat exchanger keeping the air that cycles through said structural opening closure at a constant temperature, approximately 55 degrees Fahrenheit, year round.

3. A heat transfer inhibitor for a structural opening closure as in claim 1 where said constant temperature air source utilizes a buried thermally conductive tube at sufficient depth and of a sufficient length to allow air blown through it to attain ground temperature and act as the constant temperature gas to cycle through an air-to-air heat exchanger keeping the air that cycles through said structural opening closure at a constant temperature, approximately 55 degrees Fahrenheit, year round.

4. I claim a heat transfer inhibitor for a plurality of a structural opening closures, comprised of:
a plurality of spacer frames that fit in said structural openings with tops, bottoms, side walls, interior sides and exterior sides;
exterior panels;
interior panels, where said exterior panels and said interior panels are separated by said spacer frames forming gaps between said interior and exterior panels;
top ports that penetrate through side walls of said spacer frames toward said tops into said gaps;
bottom ports that penetrate through opposite side walls of said spacer frames toward said bottoms into said gaps;
a constant temperature air source connected to said top ports by insulated tubing where said constant temperature source line is capped with a top cap after distal structural opening closure;
a constant temperature air return is capped before said proximal structural opening closure with a bottom cap and is connected to said bottom ports by said insulated tubing;
distal bottom port is connected by said insulated tubing back to of said constant temperature air return; and
said constant temperature air source and return have a flow reversing means that blows said constant temperature air into said top ports when heating is required, drawing return air through said bottom ports and returning it to said constant temperature air source and reversing the direction of flow for cooling, blows constant temperature air into said bottom ports and draws its return air from said top ports.

5. A heat transfer inhibitor for a plurality of structural opening closures as in claim 4 where said constant temperature air source utilizes a water well source of constant temperature fluid to cycle through a water-to-air heat exchanger keeping the air that cycles through said plurality of structural opening closures at a constant temperature, approximately 55 degrees Fahrenheit, year round.

6. A heat transfer inhibitor for a plurality of structural opening closures as in claim 4 where said constant temperature air source utilizes a buried thermally conductive tube at sufficient depth and of a sufficient length to allow air blown through it to attain ground temperature and act as the constant temperature gas to cycle through an air-to-air heat exchanger keeping the air that cycles through said plurality of structural opening closures at a constant temperature, approximately 55 degrees Fahrenheit, year round.
